(19) United States
(12) Patent Application Publication
(10) Pub. No.: US 2003/0143343 A1
(43) Pub. Date: Jul. 31, 2003

(54) Wall-structured body and process for manufacturing the same

(75) Inventors: Kouya Kawabata, Kanagawa (JP); Mitsuyoshi Ichihashi, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/321,804

(22) Filed: Dec. 18, 2002

(30) Foreign Application Priority Data
Dec. 19, 2001 (JP) 2001-386355

(51) Int. Cl. C09K 19/00

(52) U.S. Cl. 428/1.1; 428/1.3; 428/1.2

(57) ABSTRACT

An object of the present invention is to provide a wall-structured body having a high aspect ratio which can be produced at low cost. A wall-structured body has molecules having orientation axes, wherein the molecules are formed by polymerizing a compound having a polymerizable functional group, and the orientation axes of the molecules are aligned in one direction. The wall-structured body has molecules having orientation axes, the molecules have an orientation parameter of 0.5 or more to the orientation axes. The wall-structured body has side-surfaces which face each other and cross a horizontal plane, wherein an angle between the horizontal plane and a tangent line at ½A long from the horizontal plane is 85° to 95° in a cross-section where the wall-structured body is cut vertically to the horizontal plane and at a plane crossing the side-surfaces, when “A” expresses a length of at least one of the side-surfaces.

### BACKGROUND OF THE INVENTION

1. Field of the Invention

The present invention relates to a wall-structured body having a high aspect ratio, which is typically used in a thick resist pattern, a mold to form ribs for PDP, a structured body for micromachines, and a process for manufacturing the same.

2. Description of the Related Art

Conventional methods for forming a wall-structured body having a high aspect ratio include photolithography using a photosensitive material, and the like. However, in the photolithography, even when an exposure light beam is a parallel beam, the intensity of the light in the photosensitive material decreases according to the law of Lambert-Beer. Therefore, the amount of the exposure light cannot be constantly maintained in a depth direction.

On this account, a distribution of photochemical reaction amount occurs in a thickness direction of the exposed part, and consequently, after a step of developing, the boundary between the exposed part and the non-exposed part is not parallel to the exposure light beam. Also, even when parallel beams are used as the exposure light, the light may be diffused by diffraction at the time when it passes a photomask. Thus, it is difficult to irradiate only perfectly parallel beams in the photosensitive material. It is hence a problem that a pattern by diffused light is generally formed.

Therefore, since it is not possible to form a pattern having a high aspect ratio by ordinary photolithography, there is a need for ion beam processing, X-ray lithography, and the like, each one of which requires expensive equipment.

### SUMMARY OF THE INVENTION

An object of the present invention is to provide a wall-structured body having a high aspect ratio which can be manufactured at a low cost, and to provide an efficient process for manufacturing the same.

A wall-structured body according to the first aspect of the present invention comprises molecules having orientation axes, wherein the molecules are formed by polymerizing a compound having a polymerizable functional group, and the orientation axes of the molecules are aligned in one direction.

A wall-structured body according to the second aspect of the present invention comprises molecules having orientation axes, wherein the molecules have an orientation parameter of 0.5 or more to the orientation axes.

A wall-structured body according to the third aspect of the present invention comprises side-surfaces which face each other and cross a horizontal plane on which the wall-structured body is placed, wherein an angle between the horizontal plane and a tangent line at ½A long from the horizontal plane is 85° to 95° in a cross-section where the wall-structured body is cut in vertical direction to the horizontal plane and at a plane crossing the side-surfaces, when “A” expresses a length of at least one of the side-surfaces.

A process for manufacturing a wall-structured body according to the fourth aspect of the present invention comprises a step of forming molecules by polymerizing a compound having a polymerizable functional group, and a step of orientating the molecules to align orientation axes of the molecules in one direction, so as to form the wall-structured body.

### BRIEF DESCRIPTION OF THE DRAWING

FIG. 1 shows a schematic sectional view of one example of a wall-structured body according to the present invention.

### DESCRIPTION OF THE PREFERRED EMBODIMENTS

Now the present invention will be explained in detail hereinafter.

[Wall-structured Body]

A wall-structured body according to the first aspect of the present invention comprises molecules having orientation axes, wherein the molecules are formed by polymerizing a compound having a polymerizable functional group, and the orientation axes of the molecules are aligned in one direction.

A wall-structured body according to the second aspect of the present invention comprises molecules having orientation axes, wherein the molecules have an orientation parameter of 0.5 or more to the orientation axes.

A wall-structured body according to the third aspect of the present invention comprises side-surfaces which face each other and cross a horizontal plane on which the wall-structured body is placed, wherein an angle between the horizontal plane and a tangent line at ½A long from the horizontal plane is 85° to 95° in a cross-section where the wall-structured body is cut in vertical direction to the horizontal plane and at a plane crossing the side-surfaces, when “A” expresses a length of at least one of the side-surfaces.

Compound Having a Polymerizable Functional Group

The compound having a polymerizable functional group is not particularly limited as long as it has a polymerizable functional group and the molecule can be oriented. Examples of the compound having a polymerizable functional group include compounds such as azobenzenes, in addition to liquid crystal compounds. Of these, liquid crystal compounds are particularly suitable from the viewpoints that the liquid crystal compounds can be aligned and polymerized, and that the liquid crystal compounds can form a wall-structured body having a high aspect ratio.

Examples of the liquid crystal compounds include rod-shaped liquid crystal compounds, discotic liquid crystal compounds and the like. Of these, rod-shaped liquid crystal compounds are preferred, from the viewpoint that they can properly form a wall-structured body having a high aspect ratio. Examples of the rod-shaped liquid crystal compounds include nematic-orientated liquid crystal compounds, colesteric-orientated liquid crystal compounds, smectic-orientated liquid crystal compounds and the like. Of these, the nematic-orientated liquid crystal compounds are particularly preferred from the viewpoint that the nematic liquid crystal compounds are convenient for orientation.

Examples of the rod-shaped liquid crystal compounds include all kinds of the liquid crystal compounds comprising known liquid crystal molecules. Specific examples include azomethines, azoxy compounds, cyanobiphenyls, cyanophenylesters, benzoic acid esters, cyclohexane carboxylic acid phenylesters, cyanophenylcyclohexane compounds, cyano-substituted phenylpyridines, phenyldioxanes, tolan compounds, alkenylcyclohexylbanzonitrils, and the like. Examples of the liquid crystal molecules are shown in the following structural formulae (a) to (w).

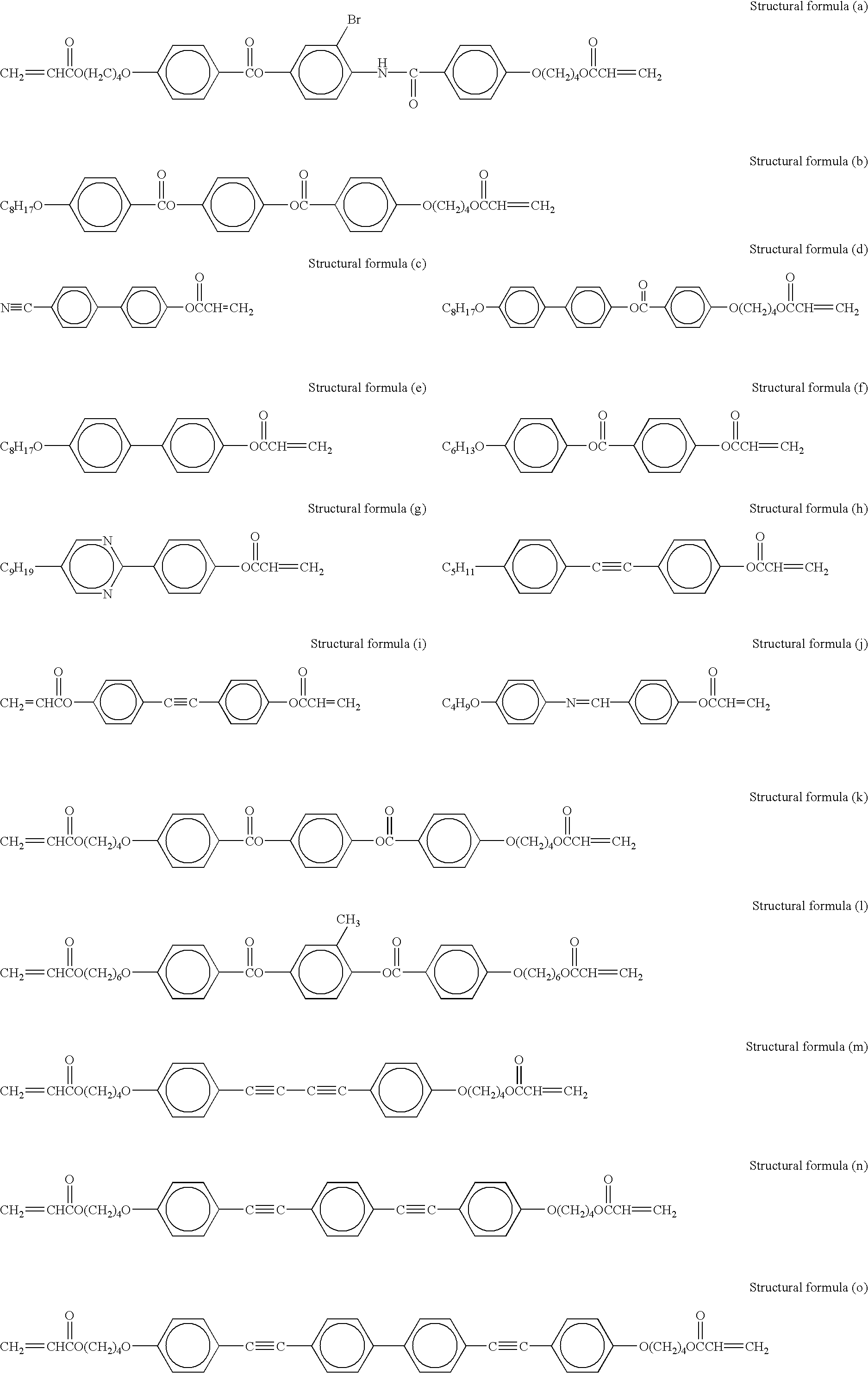

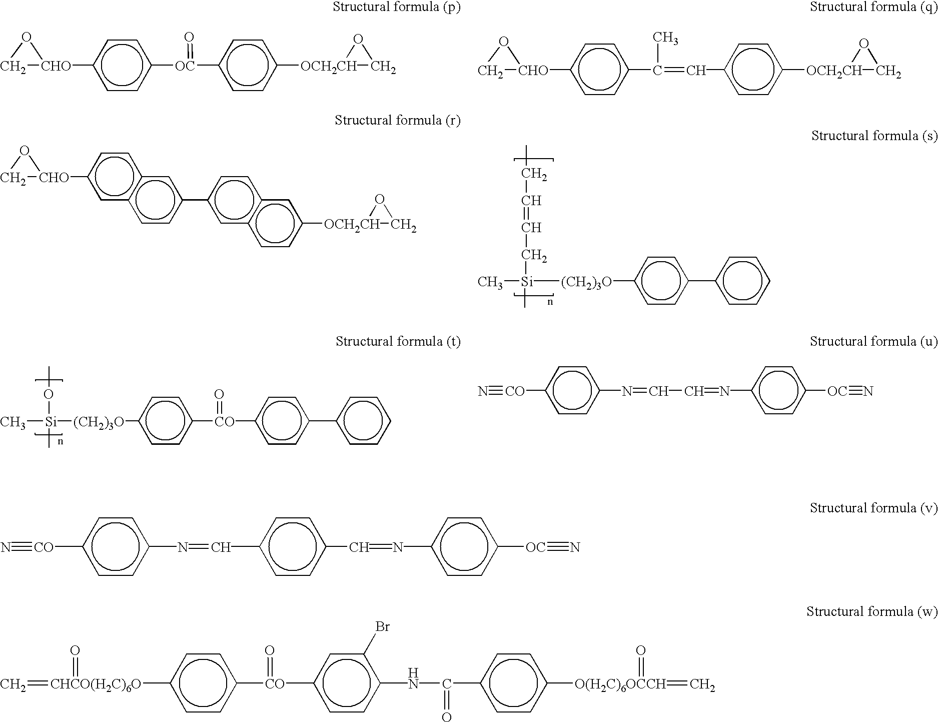

In the structural formulae (s) and (t) of the liquid crystal molecules, “n” represents an integer of 1 to 1000. Suitable examples of the compounds have side chain linkers of the following structures.

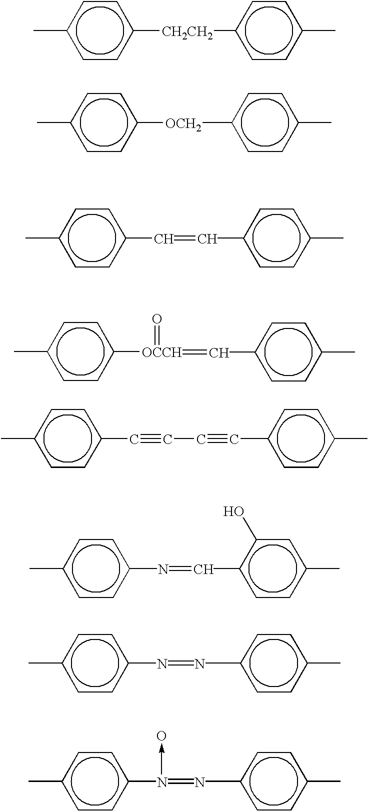

The liquid crystal compounds may additionally contain a polymerizable functional group.

Specific examples of the polymerizable functional group include the functional groups shown in ((P1) to (P18)), and the like.

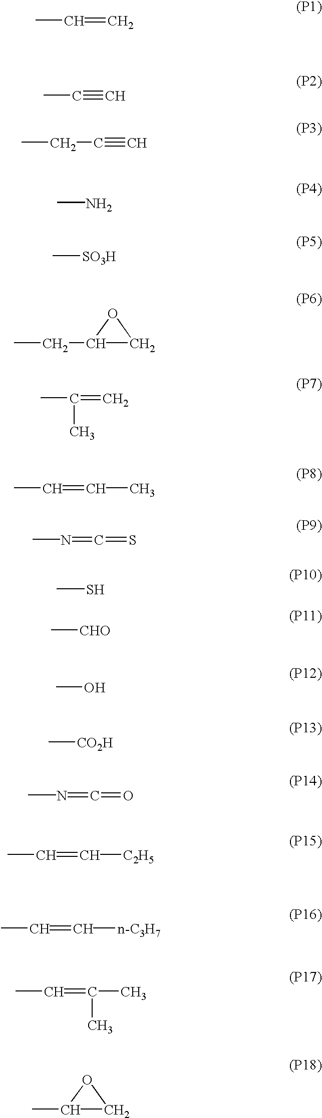

Preferred examples of the polymerizable functional group include non-saturated groups ((P1), (P2), (P3), (P7), (P8), (P15), (P16) and (P17) in the specific examples above) and epoxy groups ((P6) and (P18) in the specific examples above). Non-saturated polymerizable groups are more preferred and non-saturated polymerizable groups having ethylene ((P1), (P7), (P8), (P15), (P16) and (P17)) are preferred the most.

In the compound having a polymerizable functional group, the number of the polymerizable functional group per a molecule is preferably 2 or more, more preferably 2 to 4.

When the number of the polymerizable functional group is less than 2, the polymerization is not sufficient and a wall-structured body having a high aspect ratio cannot be formed. Also, when it exceeds 4, the light-resistance deteriorates.

The content of the compound having a polymerizable functional group in the wall-structured body is preferably 20% by mass to 99.9% by mass, more preferably 80% by mass to 99.9% by mass.

When the content is less than 20% by mass, a wall-structured body having a high aspect ratio cannot be formed. When it exceeds 99.9% by mass, the polymerization sensitivity deteriorates.

Polymerization Initial Agent

The polymerization initial agent is not particularly limited as long as it can polymerize the compound having a polymerizable functional group. However, a photopolymerization initial agent is particularly preferred. The photopolymerization initial agent is not particularly limited, and can be suitably selected from any known photopolymerization initial agent. Examples of the photopolymerization initial agent include p-methoxyphenyl-2,4-bis (trichloromethyl)-s-triazine, 2-(p-butoxystyryl)-5-trichloromethyl-1,3,4-oxadiazol, 9-phenylacrydine, 9,10-dimethylbenzphenadine, benzophenone/Michler's ketone, hexarylbiimidazol/mercaptanbenzimidazol, benzyldimethylketal, thioxantone/amine, and the like. These can be used either alone or in combination of two or more.

A content of the polymerization initial agent in the wall-structured body is preferably 0.1% by mass to 10% by mass, more preferably 0.5% by mass to 5% by mass.

When the content is less than 0.1% by mass, the polymerization is not sufficient and a pattern structure having a high aspect ratio cannot be formed. When it exceeds 10% by mass, the polymerizable compound may not be uniformly aligned.

Other Components

In addition to the compound having a polymerizable functional group and the polymerization initial agent, other components of the wall-structured body may include, for example, an air interfacial orientation agent.

Examples of the air interfacial orientation agent include compounds expressed by the following structural formulae (Q1) to (Q14). These compounds can be used either alone or in combination of two or more. Of these, the structural formulae (Q1), (Q6), (Q7), and the structural formulae (Q10) to (Q13) are preferred. The structural formula (Q6) and the structural formulae (Q10) to (Q13) are particularly preferred in order to manufacture a wall-structured body having a high aspect ratio.

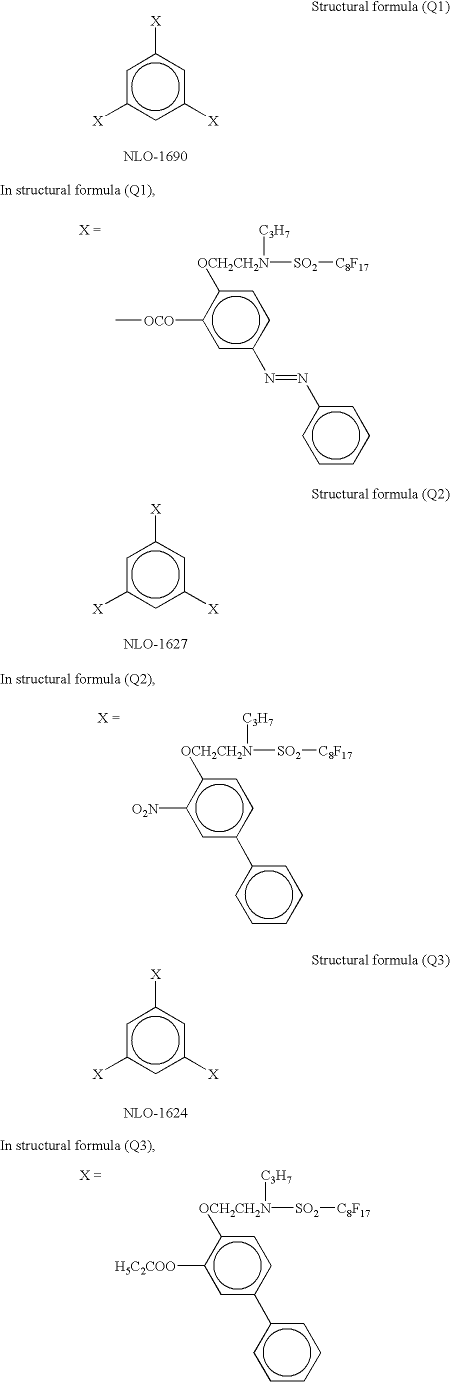

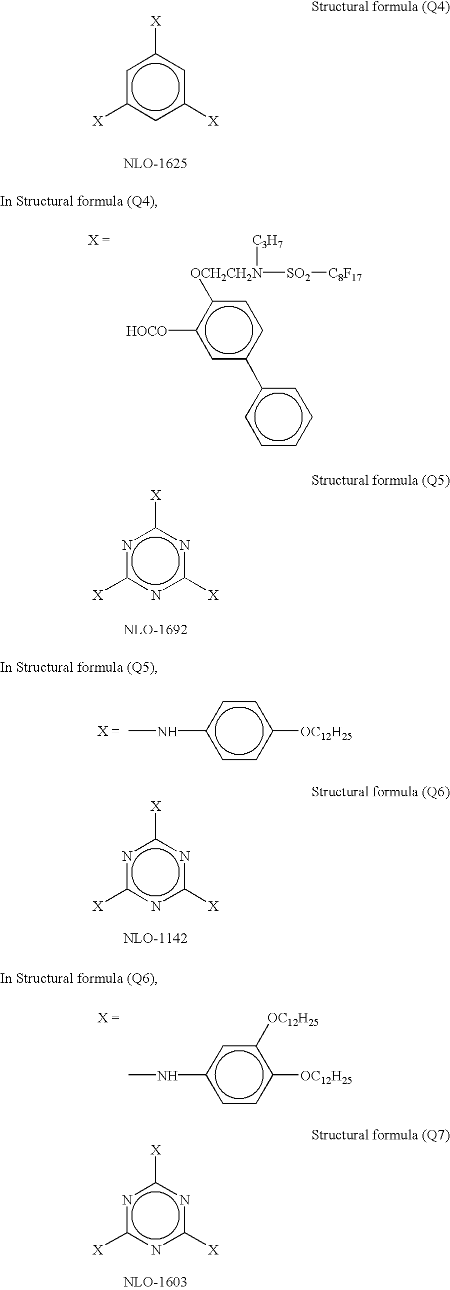

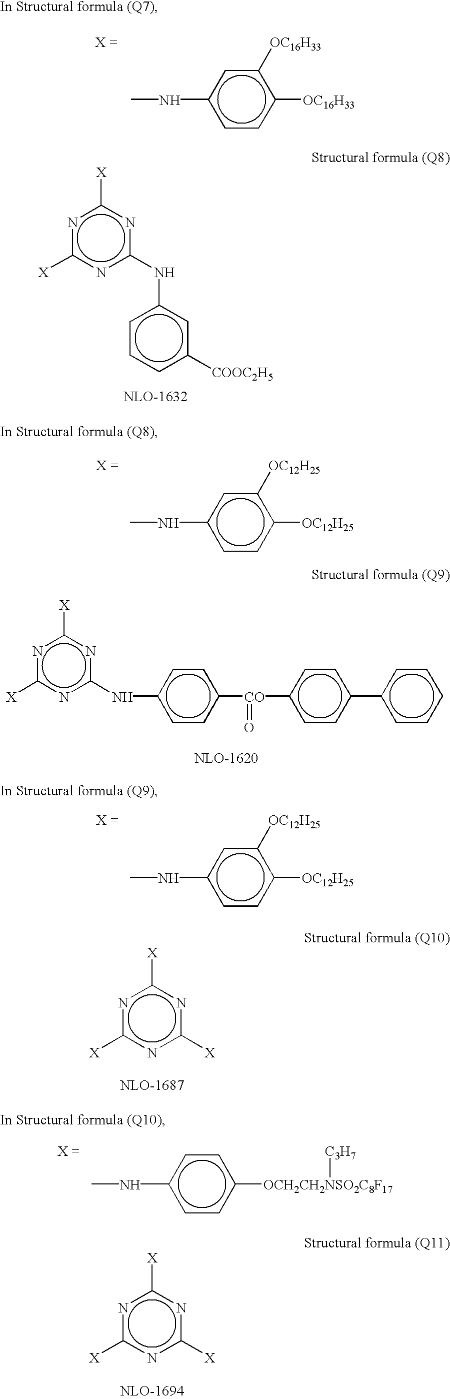

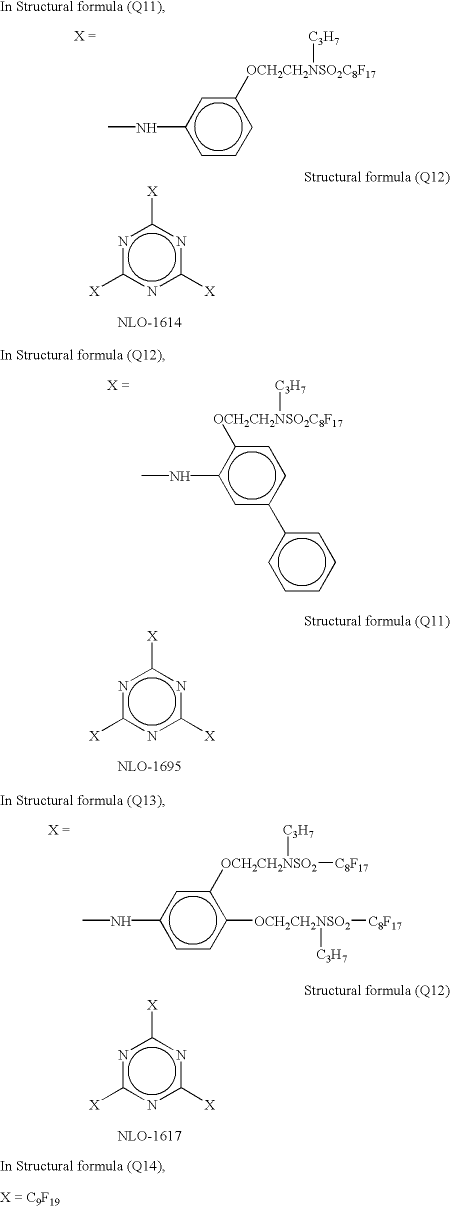

<Properties and Configuration of Wall-structured Body >

The wall-structured body has preferably an orientation parameter to an orientation axis of the contained molecule of 0.5 or more, more preferably 0.6 or more, still more preferably 0.7 or more, and particularly preferably 0.8 or more. Closer to 1 the orientation parameter is, the more preferred it is.

When the orientation parameter is 0.5 or more, a wall-structured body having a high aspect ratio can be produced.

The “orientation parameter” refers to an orientation parameter of an individual molecule. The orientation parameter is a value (P) calculated by the following formula (1), in which θ is a slope (°) of a main chain in the individual molecule to the orientation axis of the wall-structured body.

P=(3 cos ²θ−1)/2 Formula (1):

The “orientation parameter” is calculated by measuring the intrinsic birefringence of the compound having a polymerizable functional group by the IR (Infrared absorption spectrum) measurement or NMR(Nuclear Magnetic Resonance spectrum) measurement.

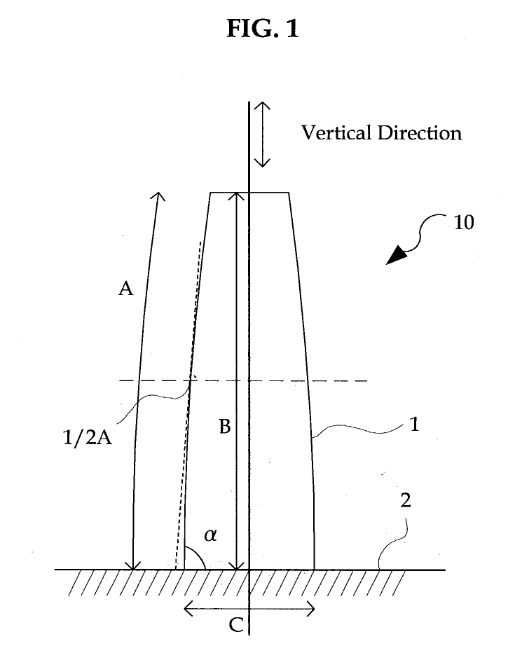

FIG. 1 shows a schematic sectional view of the wall-structured body. In the FIG. 1, the wall-structured body 10 has a side-surface 1, and is horizontally placed on a horizontal plane 2. An angle, α, between the horizontal plane and a tangent line at ½A long from the horizontal plane is 85° to 95°, when “A” expresses a length of at least one of the side-surface 1. Angles between the horizontal plane and tangent lines at ⅓A long and at ⅔A long from the horizontal plane 2 are 85° to 95°, and more preferably 90° to 95°, when “A” expresses a length of at least one of the side-surfaces.

A height “B”, which is a height of the wall-structured body, is preferably 1 μm or more, more preferably 2 μm or more, and more preferably 2 μm or more.

When the height “B” is 1 μm or more, it is possible to manufacture a wall-structured body having a high aspect ratio easily.

The aspect ratio of the wall-structured body is preferably 1 or more, and more preferably 3 or more.

The “aspect ratio” refers to the ratio expressed in B/C, when “B” expresses a height of the wall-structured body, and “C” expresses a length on a horizontal plane (a length of a portion of the wall-structured body contacting on the horizontal plane).

In an aspect ratio of the wall-structured body 10 shown in the FIG. 1 is a ratio expressed in B/C, when “B” expresses a height of the wall-structured body 10, and “C” expresses a length on the horizontal plane 2 (a length of a portion of the wall-structured body contacting on the horizontal plane).

[Process for Producing the Wall-structured Body]

A process for manufacturing a wall-structured body according to the present invention comprises a step of forming molecules by polymerizing a compound having a polymerizable functional group, after coating the compound having a polymerizable functional group and a polymerization initial agent onto a substrate; and a step of orientating the molecules to align orientation axes of the molecules in one direction, so as to form the wall-structured body.

The compound having a polymerizable functional group is selected from those described in the wall-structured body of the present invention.

Substrate

Material for the substrate is not particularly limited. Any known material can be suitably used for forming a wall-structured body. Specific examples of the material include a glass substrate, ceramic substrate, a plastic substrate, and the like. The thickness of the material is preferably about 10 μm to 10 mm.

Coating

The coating method is not particularly limited and any known methods such as spin coating, bar coating, and the like can be suitably used.

Orientation

Orientation is carried out by orientating molecules having orientation axes. The orientation can be suitably carried out by using an orientation film, by applying an external stimulation, and the like.

Examples of material for the orientation film include polyvinylalcohol (PVA), polyimide, polyamide, nylon, polystyrene, polyethylene, polyethyleneterephthalate (PET), polybutyleneterephthalate (PBT), polyester, polycyclohexylmethacrylate, polyvinylcinamate, polybrene, polyacetal, and the like. These can be used either alone or in combination of two or more.

The thickness of the orientation film is preferably 0.01 μm to 5 μm, and more preferably 0.01 μm to 1 μm. The orientation film may have an orientated surface by any known method such as a rubbing treatment.

The external stimulation is not particularly limited as long as it can align molecules having orientation axes. Examples of the external stimulation include applying magnetic field, applying light, applying electric field, applying pressure, heating, and the like. Of these, applying magnetic field, light, electric field, pressure, and the like are preferred.

When magnetic field is applied as an external stimulation, the strength of the magnetic field may be preferably 1 kG to 30 kG, more preferably 3 kG to 10 kG.

If the strength of the magnetic field is within the range 1 kG to 30 kG, the orientation can be performed well, and a wall-structured body having a high aspect ratio can be efficiently manufactured.

When light is irradiated as an external stimulation, the light may have a wavelength of preferably 100 nm to 400 nm, more preferably 200 nm to 400 nm. Also, an intensity of the light is preferably 10 (mJ/cm²) to 1000 (mJ/cm²), more preferably 10 (mJ/cm²) to 100(mJ/cm²).

If the intensity of the light is within the range between 10 (mJ/cm²) and 1000 (mJ/cm²), the orientation can be performed well, and a wall-structured body having a high aspect ratio can be efficiently manufactured.

When the light is irradiated, a photoorientation agent, which induces orientation by light, can be contained both in the compound having a polymerizable functional group and in a polymerization initial agent.

When electric field is applied as an external stimulation, the strengthen of the electric field is preferably 0.1 V to 100V, and more preferably 1 V to 10V.

If the strength of the electric field is within the range between 0.1 V and 100V, the orientation can be performed well and a wall-structured body having a high aspect ratio can be efficiently manufactured.

Applying Energy

In a process for manufacturing a wall-structured body according to the present invention, energy is applied after the step of orientating.

It is preferred that the orientated molecules having orientation axes are fixed by applying energy, subsequently to polymerizing a compound having a polymerizable functional group after forming molecules having orientation axes.

Methods for polymerizing the compound are not particularly limited. The methods can be suitably carried out by using a polymerization initial agent, and applying heat, light, or the like, to the compound.

In a process for manufacturing a wall-structured body according to the present invention, after applying energy, it is preferable to remove a portion of the orientated molecules where the energy is applied, or other portion where the energy is not applied.

A wall-structured body in a desired shape can be efficiently obtained by removing a portion.

Examples of a solvent for removing include acetone, methylethylketone, cyclohexanone and chloroform. These can be used either alone or in combination with two or more.

### EXAMPLE

Now, the present invention will be precisely described using the following example. However, the present invention is not limited to the example.

### Example 1

A composition comprising 392 parts by mass of the nematic liquid crystal compound expressed in the structural formula (w), 8 parts by mass of a polymerization initial agent (Trade name; AS-842, manufactured by Yodori Chemical, Co., Ltd., and 0.8 parts by mass of the air interfacial orientation agent (NLO-1695) expressed in the structural formula (Q13) was mixed with 1600 parts by mass of a solvent (cyclohexanone). The resulting solution was coated on a glass substrate (thickness: 700 μm) on which an orientation film (material: polyimide, thickness; 0.1 μm) is formed, by a spincoater. Light having an absorption wavelength of the polymerization initial agent (λ=330 nm) was irradiated on a photomask under a condition of the nematic phase temperature (90° C.), and then a partial area was exposed to light for ultra violet polymerization. Thereafter, non-exposed area was washed off using a solvent (methylethylketone) to form a wall-structured body on the glass substrate on which an orientation film is formed.

<Measuring a Shape and Physical Properties of the Wall-structured Body >

<<Measurement and Calculation of Orientation Parameter>>

The obtained wall-structured body was measured for its orientation parameter by the IR (Infrared absorption spectrum) measurement. The orientation parameter was 0.7.

<<Measuring an Angle Between the Horizontal Plane (Glass Surface) and a Tangent Line at the Position of ½A>>

When “A” expresses a length of a side-surface of the wall-structured body, an angle between a horizontal plane (glass surface) and a tangent line at ½A was geometrically measured by photography using SEM (Scanning Electron Microscope). The angle was 85°.

<<Measuring a Height of the Wall-structured Body>>

When “B” expresses a height of the obtained wall-structured body, the height “B” was geometrically measured by photography using SEM (Scanning Electron Microscope). The height was 50 μm.

<<Measuring and Calculating an Aspect Ratio>>

A length on a horizontal plane (glass surface) (a length of a portion of the wall-structured body contacting on the horizontal plane (glass surface)), which is “C”, was geometrically measured by photography using SEM (Scanning Electron Microscope). The aspect ratio (B/C) was 5.

According to the present invention, it is possible to provide a wall-structured body having a high aspect ratio at a low cost, and an efficient method for manufacturing the same.

What is claimed is:

1. A wall-structured body comprising:
molecules having orientation axes,
wherein the molecules are formed by polymerizing a compound having a polymerizable functional group, and the orientation axes of the molecules are aligned in one direction.

2. A wall-structured body according to claim 1, wherein the molecules have an orientation parameter of 0.5 or more to the orientation axes.

3. A wall-structured body comprising:
molecules having orientation axes,
wherein the molecules have an orientation parameter of 0.5 or more to the orientation axes.

4. A wall-structured body according to any one of claims 1 and 3,
further comprising:
side-surfaces which face each other and cross a horizontal
plane on which the wall-structured body is placed,
wherein an angle between the horizontal plane and a tangent line at ½A long from the horizontal plane is 85° to 95° in a cross-section where the wall-structure body is cut in a vertical direction to the horizontal plane and at a plane crossing the side surfaces, when “A” expresses a length of at least one of the side surfaces.

5. A wall-structured body comprising:
side-surfaces which face each other and cross a horizontal
plane on which the wall-structured body is placed,
wherein an angle between the horizontal plane and a tangent line at ½A long from the horizontal plane is 85° to 95° in a cross-section where the wall-structured body is cut in vertical direction to the horizontal plane and at a plane crossing the side-surfaces, when “A” expresses a length of at least one of the side-surfaces.

6. A wall-structured body according to any one of claims 1, 3, and 5, further comprising:
side-surfaces which face each other and cross a horizontal
plane on which the wall-structured body is placed,
wherein angles between the horizontal plane and tangent lines at ⅓A long and at ⅔A long from the horizontal plane are 85° to 95° in a cross-section where the wall-structure body is cut in a vertical direction to the horizontal plane and at a plane crossing the side-surfaces, when “A” expresses a length of at least one of the side-surfaces.

7. A wall-structured body according to any one of claim 1, 3, and 5 further comprising:
side-surfaces which face each other and cross a horizontal
plane on which the wall-structured body is placed,
wherein a height of the wall-structured body is 1 μm or more in a cross-section where the wall-structure body is cut in a vertical direction to the horizontal plane and at a plane crossing the side-surfaces.

8. A wall-structured body according to any one of claims 1, 3, and 5 further comprising:
side-surfaces which face each other and cross a horizontal
plane on which the wall-structured body is placed,
wherein an aspect ratio (B/C) of the wall-structured body is 1 or more, in a cross-section where the wall-structure body is cut in a vertical direction to the horizontal plane and at a plane crossing the side-surfaces, when “B” expresses a height of the wall-structured body, and “C” expresses a length on a horizontal plane (a length of a portion of the wall-structured body contacting on the horizontal plane).

9. A wall-structured body according to claim 1, wherein the compound having a polymerizable functional group is polymerized by a polymerization initial agent.

10. A wall-structured body according to claim 1, wherein the compound having a polymerizable functional group is a liquid crystal compound.

11. A wall-structured body according to claim 1, wherein the compound having the polymerizable functional group has 2 or more of polymerizable groups per a molecule.

12. A process for manufacturing a wall-structured body comprising the steps of:
forming molecules by polymerizing a compound having a polymerizable functional group; and
orientating the molecules to align orientation axes of the molecules in one direction, so as to form the wall-structured body.

13. A process for manufacturing a wall-structured body comprising the steps of:
forming molecules by polymerizing a compound having a polymerizable functional group; and
orientating the molecules to align orientation axes of the molecules in one direction, so as to form the wall-structured body, wherein the wall-structured body has 0.5 or more of the orientation parameter to an orientation axes of the molecules.

14. A process for manufacturing a wall-structured body comprising the steps of:
forming molecules by polymerizing a compound having a polymerizable functional group; and
orientating the molecules to align orientation axes of the molecules in one direction, so as to form the wall-structured body, wherein an angle between the horizontal plane and a tangent line at ½A long from a horizontal plane on which the wall-structured body is placed is 85° to 95° in a cross-section where the wall-structured body is cut in a vertical direction to the horizontal plane and at a plane crossing side-surfaces, when “A” expresses a length of at least one of the side-surfaces which crosses the horizontal plane and faces against the other side-surface.

15. A process for manufacturing a wall-structured body according to any one of claims 12 to 14, wherein the polymerizing is carried out by a polymerization initial agent.

16. A process for manufacturing a wall-structured body according to any one of claims 12 to 14, wherein the step of orientating is carried out by using an orientation film.

17. A process for manufacturing a wall-structured body according to any one of claims 12 to 14, wherein the step of orientating is carried out by applying an external stimulation.

18. A process for manufacturing a wall-structured body according to claim 17, wherein the external stimulation is to apply one of magnetic filed, light, and electric field.

19. A process for manufacturing a wall-structured body according to any one of claims 12 to 14, further comprising the step of:
applying energy to the molecules after the step of orientating.

20. A process for manufacturing a wall-structured body according to claim 19, further comprising the step of:
removing one of a portion of the orientated molecules where the energy is applied, and a portion of the orientated molecules where the energy is not applied.
